(19) United States
(12) Patent Application Publication
(10) Pub. No.: US 2012/0140947 A1
(43) Pub. Date: Jun. 7, 2012

(54) Apparatus and method to localize multiple sound sources

(75) Inventor: Ki Hoon Shin, Seongnam-si (KR)

(73) Assignee: Samsung Electronics Co., LTD, Suwon-si (KR)

(21) Appl. No.: 13/317,932

(22) Filed: Nov. 1, 2011

(30) Foreign Application Priority Data
Dec. 1, 2010 (KR) 10-2010-0121295

(51) Int. Cl. H04R 3/00

(52) U.S. Cl. 381/92

(57) ABSTRACT

An apparatus and method to localize multiple sound sources is provided. Virtual microphone signals are generated based on actual microphone signals from a microphone array including a plurality of microphones, which are arranged at intervals that may minimize space aliasing at a given sampling frequency, and sound source directions are tracked using the actual microphone signals and the virtual microphone signals. Thus, without increasing the aperture length of the microphone array, it is possible to achieve almost the same resolution as when a microphone array having a relatively long length is used.

### CROSS-REFERENCE TO RELATED APPLICATIONS

This application claims the priority benefit of Korean Patent Application No. 10-2010-0121295, filed on Dec. 1, 2010 in the Korean Intellectual Property Office, the disclosure of which is incorporated herein by reference.

### BACKGROUND

1. Field

Embodiments relate to an apparatus and method to localize multiple sound sources, wherein directions of multiple sound sources are estimated using a microphone array.

2. Description of the Related Art

In beamforming technology used to estimate the direction of a sound source using a linear microphone array including a plurality of microphones, direction tracking performance and angular resolution are determined based on the aperture length of the microphone array, which is the total length of the microphone array, and the distance between each microphone (i.e., inter-microphone distance).

For example, the inter-microphone distance should be smaller than a half-wavelength of the highest frequency component of sound signals from a sound source to be localized since, to correctly estimate the direction of the sound source, sound signals arriving at the microphone array from the sound source may need to be sampled at least once per half-wavelength of the highest frequency component of signals from the sound source. If the inter-microphone distance is greater than the half-wavelength of the highest frequency component of sound signals from a sound source to be localized, it is estimated that a single sound is received from multiple directions since phase differences between signals arriving at the microphones from a certain direction are not correctly measured. This is referred to as “space aliasing”.

Once the inter-microphone distance is determined, the aperture length of the microphone array, i.e., the total length thereof, is determined according to the number of microphones. If the aperture length is large, it may be possible to more accurately track the direction of a sound source, increasing direction tracking performance and resolution, since phase differences between signals that the microphones have received from a certain direction are more distinct than when the aperture length is small in the case where the signals are sampled at the same sampling frequency.

Therefore, a beamformer installed such that the aperture length is maximized at a given sampling frequency and a large number of microphones are arranged at small intervals within the aperture length is optimal for simultaneously tracking a plurality of sound sources since space aliasing is low and tracking performance and resolution are high.

However, increasing the aperture length is limited due to product design or size and the number of microphones that can be used, and is also limited due to product price. In this case, generally, tradeoff between space aliasing and resolution occurs since a microphone array may need to be installed using a limited number of microphones within a given space. That is, to increase resolution, it may be necessary to increase the aperture length. However, if the aperture length is increased, it may not be possible to prevent space aliasing since the inter-microphone distance is increased. On the other hand, if microphones are arranged such that the inter-microphone distance is smaller than a half-wavelength of the highest frequency component of a sound source in order to prevent space aliasing, the aperture length is reduced and the resolution is decreased, since the number of microphones is limited.

Accordingly, there may be a need to provide a method to increase direction tracking performance and resolution and to reduce space aliasing, without increasing aperture length, when constructing a microphone array using a limited number of microphones within a limited space.

### SUMMARY

Therefore, it is an aspect of one or more embodiments to provide an apparatus and method to localize multiple sound sources, which increases sound source direction tracking performance and resolution without increasing aperture length of a microphone array while maintaining an inter-microphone distance of the microphone array that may minimize space aliasing at a given sampling frequency.

Additional aspects of the invention will be set forth in part in the description which follows and, in part, will be apparent from the description, or may be learned by practice of the invention.

In accordance with an aspect of one or more embodiments, an apparatus to localize multiple sound sources includes a microphone array including a plurality of linearly arranged microphones, and a sound source tracking unit to perform primary estimation of a plurality of sound source directions using microphone signals received from the microphone array, generate a virtual microphone signal based on the received microphone signals for each of the primarily estimated sound source directions, and perform secondary estimation of the plurality of sound source directions using the received microphone signals and the generated virtual microphone signals.

The sound source tracking unit may include a first beamformer to receive microphone signals from the microphone array and perform beamforming using the received microphone signals to perform primary estimation of a plurality of sound source directions, a virtual microphone signal generator to generate a virtual microphone signal based on the received microphone signals for each of the primarily estimated sound source directions, and a second beamformer to perform beamforming using the received microphone signals and the generated virtual microphone signal to perform secondary estimation of the plurality of sound source directions.

The first beamformer may calculate delay values of a plurality of sound source directions for each microphone pair of the microphone array, perform Discrete Fourier Transform (DFT) on the microphone signals received from the microphone array, calculate a cross-spectrum of each microphone pair using the DFTed microphone signals, calculate a cross-correlation of each microphone pair according to the calculated cross-spectrum of the microphone pair, calculate beamformer energies of each sound source for corresponding sound source directions according to the calculated cross-correlation and the calculated delay values, and estimate a direction, which has highest energy among the calculated beamformer energies of the sound source for the corresponding sound source directions, to be a direction of the sound source.

The first beamformer may apply a weight to the cross-correlation when calculating the cross-correlation while increasing the applied weight when a frequency band of the microphone signals is higher than a preset band and decreasing the applied weight when the frequency band of the microphone signals is lower than the preset band.

The virtual microphone signal generator may generate the virtual microphone signal based on microphone signals received from the microphone array and the primarily estimated sound source directions, assuming that a virtual microphone is located at either side of the microphone array at a preset distance from a center of the microphone array.

The second beamformer may estimate, for each of the primarily estimated sound source directions, a corresponding sound source direction based on a Fourier transform of the generated virtual microphone signal, Fourier transforms of the microphone signals received from the microphone array, and the cross-correlation calculated by the first beamformer.

The second beamformer may calculate a delay value of a corresponding sound source direction for each microphone pair in all microphones including the microphones of the microphone array and the virtual microphone, calculate cross-spectrums of all the microphone pairs according to a Fourier transform of the virtual microphone signal and the Fourier transforms of the microphone signals received from the microphone array, calculate cross-correlations of all the microphone pairs according to the calculated cross-spectrums of all the microphone pairs, calculate beamformer energies of each sound source for corresponding sound source directions according to the calculated cross-correlations and the calculated delay value, and estimate a direction, which has highest energy among the calculated beamformer energies of the sound source for the corresponding sound source directions, to be a direction of the sound source.

The microphones of the microphone array may be arranged at intervals that minimize space aliasing at a given sampling frequency.

In accordance with another aspect of one or more embodiments, there is provided a method to control an apparatus to localize multiple sound sources, the apparatus including a microphone array including a plurality of linearly arranged microphones and a sound source tracking unit to estimate sound source directions according to microphone signals received from the microphone array, the method including performing primary estimation of a plurality of sound source directions using microphone signals received from the microphone array, generating a virtual microphone signal based on the received microphone signals for each of the primarily estimated sound source directions, and performing secondary estimation of the plurality of sound source directions using the received microphone signals and the generated virtual microphone signals.

Performing primary estimation of the plurality of sound sources may include calculating delay values of a plurality of sound source directions for each microphone pair of the microphone array, performing Discrete Fourier Transform (DFT) on the microphone signals received from the microphone array, calculating a cross-spectrum of each microphone pair using the DFTed microphone signals, calculating a cross-correlation of each microphone pair according to the calculated cross-spectrum of the microphone pair, calculating beamformer energies of each sound source for corresponding sound source directions according to the calculated cross-correlation and the calculated delay values, and estimating a direction, which has highest energy among the calculated beamformer energies of the sound source for the corresponding sound source directions, to be a direction of the sound source.

Calculating the cross-correlation may include applying a weight to the cross-correlation when calculating the cross-correlation while increasing the applied weight when a frequency band of the microphone signals is higher than a preset band and decreasing the applied weight when the frequency band of the microphone signals is lower than the preset band.

Generating the virtual microphone signal may include generating the virtual microphone signal based on microphone signals received from the microphone array and the primarily estimated sound source directions, assuming that a virtual microphone is located at either side of the microphone array at a preset distance from a center of the microphone array.

Performing secondary estimation of the plurality of sound sources may include estimating, for each of the primarily estimated sound source directions, a corresponding sound source direction based on a Fourier transform of the generated virtual microphone signal, Fourier transforms of the microphone signals received from the microphone array, and the calculated cross-correlation.

Performing secondary estimation of the plurality of sound source directions may include calculating a delay value of a corresponding sound source direction for each microphone pair in all microphones including the microphones of the microphone array and the virtual microphone, calculating cross-spectrums of all the microphone pairs according to a Fourier transform of the virtual microphone signal and the Fourier transforms of the microphone signals received from the microphone array, calculating cross-correlations of all the microphone pairs according to the calculated cross-spectrums of all the microphone pairs, calculating beamformer energies of each sound source for corresponding sound source directions according to the calculated cross-correlations and the calculated delay value, and estimating a direction, which has highest energy among the calculated beamformer energies of the sound source for the corresponding sound source directions, to be a direction of the sound source.

### BRIEF DESCRIPTION OF THE DRAWINGS

These and/or other aspects of one or more embodiments will become apparent and more readily appreciated from the following description of embodiments, taken in conjunction with the accompanying drawings of which:

FIG. 1 illustrates a configuration of an apparatus to localize multiple sound sources according to an embodiment;

FIG. 2 illustrates a flow chart illustrating a method for controlling the apparatus to localize multiple sound sources according to an embodiment;

FIG. 3 is a control block of the apparatus to localize multiple sound sources according to an embodiment;

FIG. 4 illustrates a relationship between sound source directions and a microphone array including linearly arranged microphones in the apparatus to localize multiple sound sources according to an embodiment;

FIG. 5A is a graph illustrating a beamforming result of the microphone array whose aperture length is fixed to 16 cm and whose inter-microphone distance is fixed to 4 cm at a sampling frequency of 8 kHz when sound sources are present at angles of 0 and 40 degrees in the apparatus to localize multiple sound sources according to an embodiment;

FIG. 5B is a graph illustrating a beamforming result of the microphone array whose aperture length is fixed to 16 cm and whose inter-microphone distance is fixed to 4 cm at a sampling frequency of 8 kHz when sound sources are present at angles of 0 and 20 degrees in the apparatus to localize multiple sound sources according to an embodiment;

FIGS. 6A and 6B illustrate the operation of the first beamformer of the apparatus to localize multiple sound sources according to an embodiment;

FIG. 7 illustrates the concept of virtual microphone signals in the apparatus to localize multiple sound sources according to an embodiment;

FIG. 8 illustrates the operation of a virtual microphone signal generator in the apparatus to localize multiple sound sources according to an embodiment; and

FIG. 9 illustrates the operation of a second beamformer of the apparatus to localize multiple sound sources according to an embodiment.

### DETAILED DESCRIPTION

Reference will now be made in detail to embodiments, examples of which are illustrated in the accompanying drawings, wherein like reference numerals refer to like elements throughout.

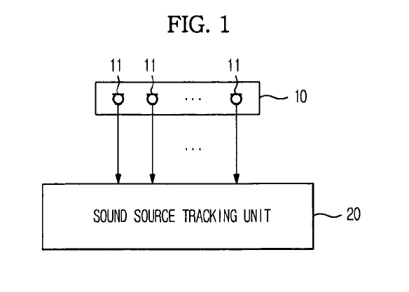

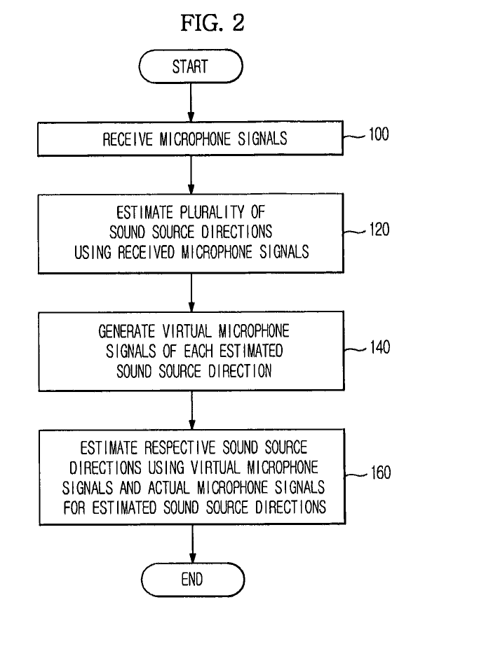

FIG. 1 illustrates a configuration of an apparatus to localize multiple sound sources according to an embodiment. FIG. 2 illustrates a flow chart illustrating a method for controlling the apparatus to localize multiple sound sources according to an embodiment.

As shown in FIG. 1, the apparatus to localize multiple sound sources includes a microphone array 10 and a sound source tracking unit 20.

The microphone array 10 includes a plurality of microphones 11 which are linearly arranged at equal intervals to receive sound source signals.

The sound source tracking unit 20 performs beamforming using actual microphone signals received by the microphone array 10 to perform primary estimation of a plurality of sound source directions and generates virtual microphone signals of each of the primarily estimated sound source directions based on the actual microphone signals received by the microphone array 10. The sound source tracking unit 20 then performs beamforming using the generated virtual microphone signals and the actual microphone signals received by the microphone array 10 to perform secondary estimation of a plurality of sound source directions.

The operation of the sound source tracking unit 20 will now be described in more detail with reference to FIG. 2. First, the sound source tracking unit 20 receives a plurality of microphone signals from the microphone array 10 (100).

The sound source tracking unit 20 performs beamforming, which is described later, using the plurality of received microphone signals to perform primary estimation of a plurality of sound source directions (120).

After performing primary estimation of the plurality of sound source directions, the sound source tracking unit 20 generates a pair of virtual microphone signals for each of the primarily estimated sound source directions from both the primarily estimated directions and the microphone signals, assuming that a pair of virtual microphones are present at both sides of the microphone array 10 at a distance therebetween that is several times greater than the aperture length (140).

After generating the virtual microphone signals, the sound source tracking unit 20 performs beamforming using the actual microphone signals received from the microphone array 10 and the generated virtual microphone signals to perform secondary estimation of a plurality of sound source directions (160).

The apparatus to localize multiple sound sources according to an embodiment may increase resolution without an actual interval between microphones since sound source directions are estimated assuming that two virtual microphones are added at both sides of the microphone array 10 as described above.

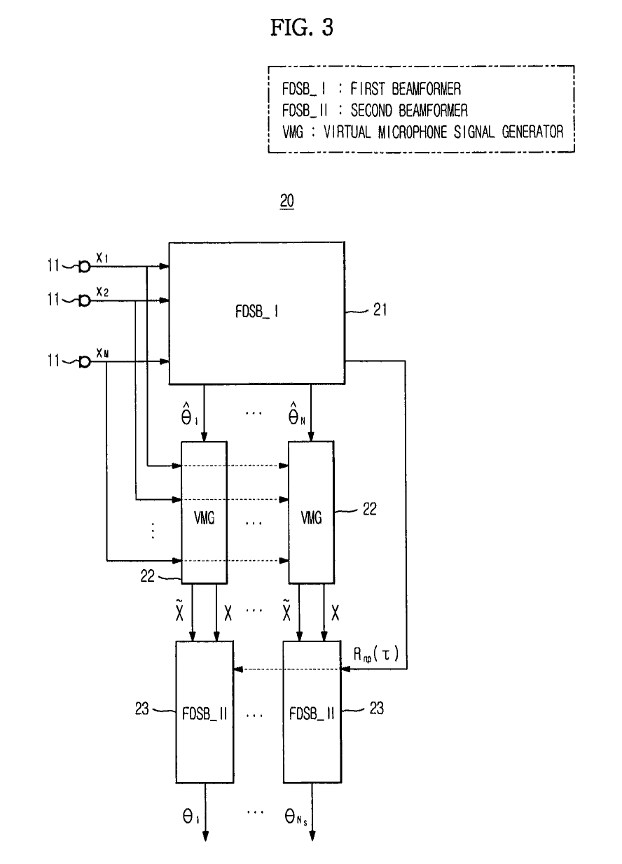

FIG. 3 is a control block of the apparatus to localize multiple sound sources according to an embodiment.

As shown in FIG. 3, the sound source tracking unit 20 includes a first beamformer 21 (Frequency-Domain Steered Beamformer I (FDSB_I)), virtual microphone signal generators 22 (Virtual Microphone Generators (VMGs)), and second beamformers 23 (Frequency-Domain Steered Beamformers II (FDSB_μl)).

The first beamformer 21 receives actual microphone signals from the microphone array 10 and performs beamforming using the received actual microphone signals to perform primary estimation of a plurality of sound source directions. That is, the first beamformer 21 estimates a plurality of sound source directions based on the actual microphone signals received from the microphone array 10 and provides the estimated sound source directions respectively to the virtual microphone signal generators 22.

Each of the virtual microphone signal generators 22, which correspond respectively to the sound source directions primarily estimated by the first beamformer 21, generates virtual microphone signals for the corresponding one of the primarily estimated sound source directions based on the actual microphone signals received from the microphone array 10. Specifically, the virtual microphone signal generators 22 generate respective pairs of virtual microphone signals for the sound source directions estimated by the first beamformer 21 based on the actual microphone signals and provide the generated pairs of virtual microphone signals to the second beamformers 23, respectively.

The second beamformers 23 perform beamforming using the actual microphone signals received from the microphone array 10 and the virtual microphone signals generated by the virtual microphone signal generators 22 in order to perform secondary estimation of a plurality of sound source directions. That is, the second beamformers 23 estimate corresponding sound source directions using the actual microphone signals received from the microphone array 10 and the virtual microphone signals generated by the virtual microphone signal generators 22.

The following is a description of general beamforming performed by the first beamformer.

The first beamformer 21 receives sound source signals from the microphone array 10 including M microphones 11 that are arranged in a line.

Outputs of the first beamformer 21 are defined as follows.

$$y ( n ) = {\sum }_{m = 0}^{M - 1} {x}_{m} ( n - {τ}_{m} ) \qquad Expression 1$$

Here, xₘ(n) denotes an m^{th} microphone signal and τₘ denotes a delay of arrival (DOA) to the m^{th} microphone 11.

The following is an output energy E of the first beamformer 21 calculated for each microphone signal frame having a length of L.

$$E = {\sum }_{n = 0}^{L - 1} {[ y ( n ) ]}^{2} = {\sum }_{n = 0}^{L - 1} {[ {x}_{0} ( n - {τ}_{0} ) + … + {x}_{M - 1} ( n - {τ}_{M - 1} ) ]}^{2} \qquad Expression 2$$

In the case where a sound source is present in a direction, τₘ represents delays of signals that arrive at the microphones 11 from the direction. If the outputs of the first beamformer 21 are corrected and summed as expressed in Expression 2, then the energy of the first beamformer 21 is maximized. Expression 2 may be rearranged for each pair of microphones as follows.

$$E = {\sum }_{m = 0}^{M - 1} {\sum }_{n = 0}^{L - 1} {x}_{m}^{2} ( n - {τ}_{m} ) + 2 {\sum }_{i = 0}^{M - 1} {\sum }_{j = 0}^{i - 1} {\sum }_{n = 0}^{L - 1} {x}_{i} ( n - {τ}_{i} ) {x}_{j} ( n - {τ}_{j} ) \qquad Expression 3$$

The first term of Expression 3 is the sum of auto-correlations of the microphone signals. If the first term is ignored since the value of the first term is nearly constant for various values of τₘ, the second term is represented by cross-correlations between different i^{th} and j^{th} microphones 11, and the value of “2” at the head of the second term is ignored, then the output energy E of the first beamformer 21 is proportional to the sum of cross-correlations between different microphone signals as follows.

$$E ∝ {\sum }_{i = 0}^{M - 1} {\sum }_{j = 0}^{i - 1} {R}_{{x}_{i} {x}_{j}} ( τ ) \qquad Expression 4$$

Here, τ is a relative delay τᵢ-τⱼ between the i^{th} microphone 11 and the j^{th} microphone 11. This indicates that the cross-correlations are each a function of the relative delay between microphone signals, assuming that the microphone signals are Wide-Sense Stationary (WSS). In the frequency domain, the cross-correlations are represented by the following approximate values.

$${R}_{{x}_{i} {x}_{j}} ( τ ) \approx {\sum }_{k = 0}^{L - 1} {X}_{i} ( k ) {X}_{j}^{*} ( k ) {e}^{( \sqrt{- 1} ) 2 π k τ / L} \qquad Expression 5$$

Here, Xᵢ(k) denotes a Discrete Fourier Transform (DFT) of the i^{th} microphone signal xᵢ(n), Xᵢ(k)Xⱼ*(k) denotes a cross-spectrum of xᵢ(n) and xⱼ(n), and * denotes complex conjugate. In addition, k is a frequency index of DFT and L denotes DFT magnitude while representing the length of each microphone signal frame.

However, if Expression 5 is used without change, cross-correlation peaks are not sharp and all frequency components are equally applied such that specific frequency components, which are mostly those of ambient noise rather than those of sound sources to be localized, also equally contribute to the cross-corrections, thereby making it difficult to detect sound sources having a small bandwidth such as voice.

Accordingly, whitening is performed through normalization based on the absolute value of each DFT and spectral weighting is applied to apply a higher weight to a spectrum having a higher Signal-to-Noise Ratio (SNR).

$${\hat{R}}_{{x}_{i} {x}_{j}} ( τ ) = {\sum }_{k = 0}^{L - 1} \frac{{w}^{2} ( k ) {X}_{i} ( k ) {X}_{j}^{*} ( k )}{\vert {X}_{i} ( k ) \vert \vert {X}_{j} ( k ) \vert} {e}^{( \sqrt{- 1} ) 2 π k τ / L} \qquad Expression 6$$

Here, the weight of each frequency w(k) is obtained as follows based on an average Y(k) of the power spectral densities of all microphone signals obtained at the current time and an average Y_{N}(k) of values Y(k) obtained at a previous time.

$$w ( k ) = \{ \begin{matrix}1 , & Y ( k ) \leq {Y}_{N} ( k ) \\ {( \frac{Y ( k )}{{Y}_{N} ( k )} )}^{β} , & Y ( k ) > {Y}_{N} ( k )\end{matrix} \qquad Expression 7$$

Here, β(0<β<1) is a weight applied to frequency components having a larger value than the average spectrum of previous signals.

A cross-correlation of each microphone pair is obtained by substituting an average of Xᵢ(k)X*ⱼ(k) obtained for a specific time period (for example, 200 msec) into Expression 6.

Since M*(M−1)/2 different microphone pairs are present for the microphone array 10 including M microphones 11, M*(M−1)/2 cross-correlations are calculated and substituted into Expression 4 to obtain a beamformer energy E.

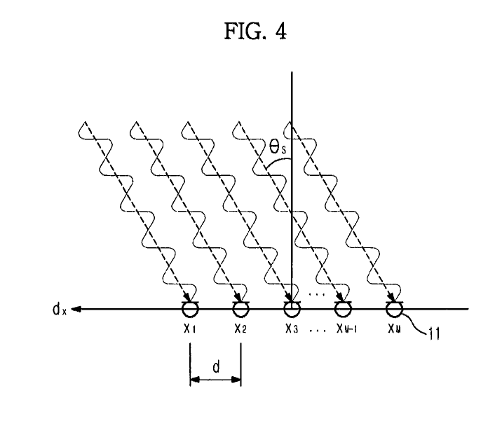

The energy E of the first beamformer 21 obtained in this manner is a function of the delay difference between each microphone pair and the delay difference t between the i^{th} microphone 11 and the j^{th} microphone 11, is represented as follows using the sound source direction θ_{S} and the interval dᵢⱼ between the microphone pair in the microphone array 10 including M microphones 11 as shown in FIG. 4.

$${τ}_{ij} = \frac{{d}_{ij} sin ( {θ}_{s} )}{c} \qquad Expression 8$$

Here, c is the speed of sound in air. When the microphone interval d and a sampling frequency f_{S} of the first beamformer 21 are determined, the number of directions N_{d} that may be tracked by the first beamformer 21 may be approximated using the following Expression.

$${N}_{d} \approx 1 + \frac{2 d}{c} {f}_{s} \qquad Expression 9$$

In the case where the beamforming is performed using the microphone array 10, the range of directions to be tracked is limited to between −90° and 90° assuming that the front direction is 0°. Therefore, dividing 180° by N_{d} gives the angular resolution of the first beamformer 21. The delay difference between each microphone pair for the N_{d} directions, is obtained using Expression 8, the obtained delay difference is substituted into the previously calculated cross-correlation (Expression 6), and the energy E of the first beamformer 21 is then obtained for each of the N_{d} directions using Expression 4. A direction that maximizes the energy E is determined to be a sound source direction in each time period.

In the case where a plurality of sound sources is simultaneously tracked, all directions are scanned to obtain the energy E of the first beamformer 21 as when one sound source is tracked. However, when a direction of a sound source has already been determined, remaining directions are scanned and one of the remaining directions, which maximizes the energy E, is determined to be a direction of a next sound source.

Meanwhile, once a sampling frequency of a beamformer to be mounted on a product or a system is determined, an inter-microphone distance d is set so as to prevent space aliasing and microphones are arranged at intervals of the set inter-microphone distance d. Here, the inter-microphone distance d may need to be close to or less than a half-wavelength of a Nyquist frequency f_{Nyquist} that is half of the sampling frequency. That is, the inter-microphone distance d may satisfy the following Expression.

$$d \leq \frac{c}{2 {f}_{Nyquist}} \qquad Expression 10$$

For example, microphones may be arranged at intervals of 4 cm when the sampling frequency is 8 kHz and may be arranged at intervals of 2 cm when the sampling frequency is 16 kHz to prevent space aliasing.

However, the number of microphones that may be used is limited to reduce product manufacturing costs and, if the limited number of microphones are arranged closely, the total aperture length is reduced, thus decreasing angular resolution.

Therefore, generally, space aliasing is ignored and microphones are arranged at large intervals in order to increase resolution. Although this method is suitable for a beamformer designed to separate sound sources, which receives sound from a specific direction better than from other directions, the method may not be suitable for a beamformer designed to correctly track directions of sound sources.

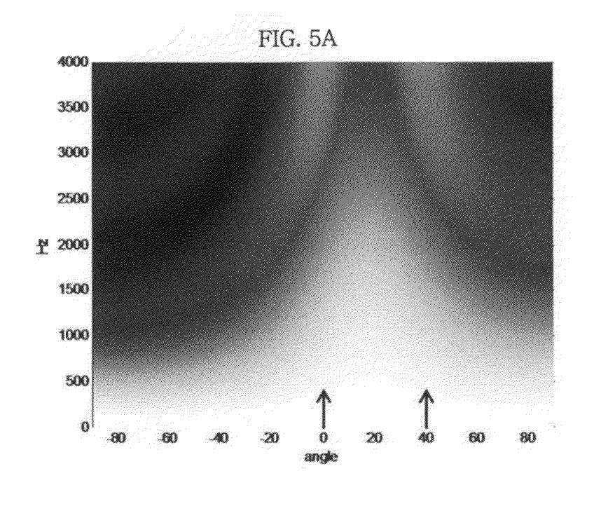

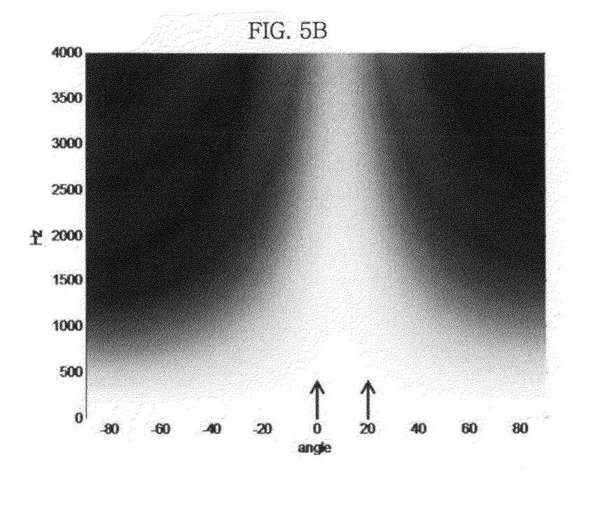

FIG. 5A is a graph illustrating a beamforming result of the microphone array 10 whose aperture length is fixed to 16 cm and whose inter-microphone distance is fixed to 4 cm at a sampling frequency of 8 kHz when sound sources are present at angles of 0 and 40 degrees in the apparatus to localize multiple sound sources according to an embodiment. FIG. 5B is a graph illustrating a beamforming result of the microphone array 10 whose aperture length is fixed to 16 cm and whose inter-microphone distance is fixed to 4 cm at a sampling frequency of 8 kHz when sound sources are present at angles of 0 and 20 degrees in the apparatus to localize multiple sound sources according to an embodiment. In the graphs of FIGS. 5A and 5B, the vertical axis represents the Nyquist frequency f_{Nyquist}(NI) that is half of the sampling frequency and the horizontal axis represents angle.

Although the condition that the inter-microphone distance of the microphone array 10 is 4 cm when the sampling frequency is 8 kHz does not cause space aliasing since the condition satisfies Expression 10, the condition may not be suitable for tracking a plurality of sound sources since beam thickness is increased due to low resolution as can be seen from FIGS. 5A and 5B. In FIGS. 5A and 5B, arrows represent directions of the sound sources and brighter color indicates a higher signal amplification at a corresponding angle.

Substituting this condition into Expression 9 determines the number of directions that may be tracked to be about 3 and dividing the total tracking range of about 180 degrees (from about −90 degrees to about 90 degrees) by 3 yields 60 degrees. Therefore, the resolution of the first beamformer 21 is about 60 degrees. FIG. 5A shows a beamforming result for 0 and 40 degrees and FIG. 5B shows a beamforming result for 0 and 20 degrees.

It may be seen from FIG. 5A that, if the distance between sound sources is large, the same sound source directions as actual sound source directions, i.e., sound source directions having the angles of 0 and 40 degrees, are separated at high frequency components above 2.5 kHz, whereas sound source directions having about the mean of the angles are separated at low frequency components.

That is, the tracked directions of the sound sources vary with time depending on the distribution of frequency components of the sound sources to be localized with respect to time. On the other hand, it may be seen from FIG. 5B that, if the distance between two sound sources is small, the values of the tracked directions of the two sound sources are uniform with time between the actual directions of the two sound sources over all frequency regions other than low frequencies since the two beams are combined into one thick beam.

Accordingly, in an embodiment, signals of virtual microphones are generated assuming that the virtual microphones are present at both sides of the microphone array while maintaining the inter-microphone distance of the microphone array at a value that may prevent space aliasing at a given sampling frequency, and the generated signals of the virtual microphones are used together with the actual microphone signals when estimating sound source directions to increase resolution without increasing the aperture length of the microphone array.

The first beamformer 21 operates in the following manner. In the case where increase in the aperture length of the microphone array is limited due to product design or size, the value of each sound source direction estimated by the first beamformer 21 varies every time period due to a low resolution of the actual microphone array.

Accordingly, the positions of the actual sound sources may need to be more correctly estimated in order to generate virtual microphone signals, which are located distant from the microphone array 10, so as to be closer to actual microphone signals.

If the distance between sound sources is great, a cross-correlation between each microphone pair is obtained as follows by applying a greater weight to a high frequency band since the high frequency band may approximately represent directions of sound sources.

$${R}_{np} ( τ ) = {\sum }_{k = 0}^{L - 1} \frac{{μ}^{2} ( k ) {w}^{2} ( k ) {X}_{i} ( k ) {X}_{j}^{*} ( k )}{\vert {X}_{i} ( k ) \vert \vert {X}_{j} ( k ) \vert} {e}^{( \sqrt{- 1} ) 2 π k τ / L} \qquad Expression 11$$

Here, w(k) is obtained using Expression 7 and a total frequency band is divided into two parts, a low frequency region and a high frequency region, and a value less than 1 is applied as an additional weight μ(k) to the low frequency region and a value higher than 1 is applied as an additional weight μ(k) to the high frequency region.

$$μ ( k ) = \{ \begin{matrix}< 1 , & k \leq \frac{L}{4} \\ > 1 , & otherwise\end{matrix} \qquad Expression 12$$

The total number of different microphone pairs Nₚ in the microphone array 10 including M microphones 11 is M*(M−1)/2 and “np” in Expression 11 is a microphone pair index. For example, as shown in Table 1, if the number of microphones is 5, “np” has values from 1 to 10 since 10 microphone pairs are present. Respective cross-correlations of the microphone pairs are calculated using Expression 11 in advance.

TABLE 1

| Mic. Index | j = 2 | j = 3 | j = 4 | j = 5 |
|---|---|---|---|---|
| i = 1 | 1 | 2 | 3 | 4 |
| i = 2 | — | 5 | 6 | 7 |
| i = 3 | — | — | 8 | 9 |
| i = 4 | — | — | — | 10 |

Table 1 shows exemplary microphone pair indices when the microphone array includes 5 microphones.

As shown in FIG. 5B, if the distance between sound sources is relatively small, beamwidth is very large in a low frequency region. Therefore, applying a greater weight to a high frequency region using Expression 12 is more advantageous than to apply a uniform weight to the entire frequency region in correctly tracking actual sound source directions.

In addition, the difference of influences of two sound sources spaced at a small interval exerted upon virtual microphone signals decreases as the distance of the virtual microphones from the center of the microphone array 10 increases.

Accordingly, the first beamformer 21 performs beamforming processes in the same order as described above by replacing the equation of cross-correlations between microphone pairs of Expression 6 with Expression 11.

The following is a description of the operation of the first beamformer 21.

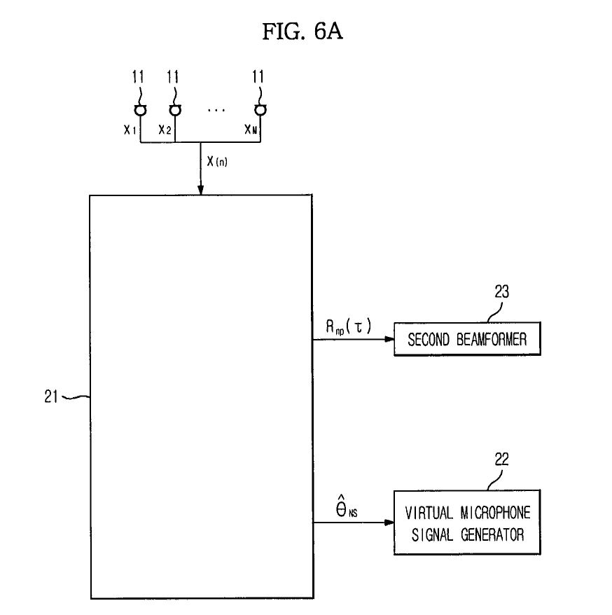

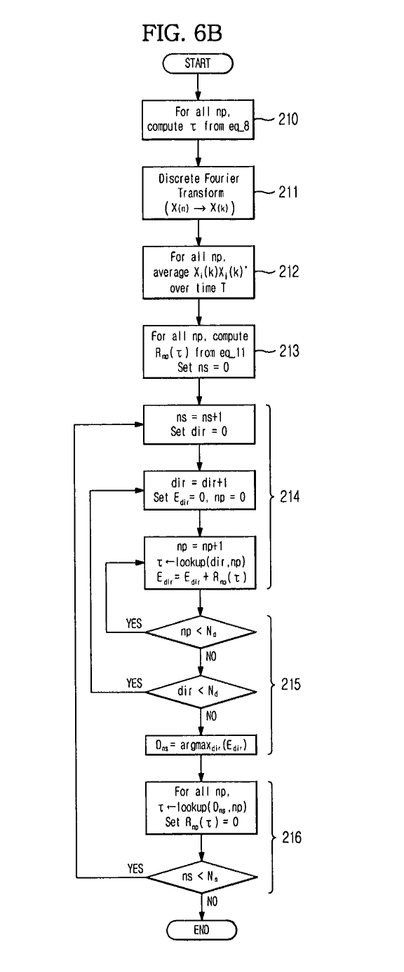

FIGS. 6A and 6B illustrate the operation of the first beamformer of the apparatus to localize multiple sound sources according to an embodiment.

As shown in FIGS. 6A and 6B, first, upon receiving microphone signals from the microphone array 10, the first beamformer 21 calculates respective delays i of N_{d} sound source angles θ_{S} for each microphone signal of the microphone array 10 using Expression 8 (210). The calculated delay values are stored in a table in association with the respective microphone pairs (see Table 1).

The first beamformer 21 then performs Discrete Fourier Transform (DFT) on the microphone signals x(n) received from the microphone array 10 to calculate DFTs X(k) of the microphone signals x(n) (211).

After performing DFT on the microphone signals, the first beamformer 21 calculates Xᵢ(k)X*ⱼ(k) which is a cross-spectrum of each microphone pair using microphone signals received for a predetermined time period T (212).

After calculating a cross-spectrum of each microphone pair, the first beamformer 21 calculates a cross-correlation Rₙₚ(τ) of each microphone pair. For example, when the number of microphones of the microphone array 10 is M, the first beamformer 21 calculates M*(M−1)/2 cross-correlations Rₙₚ(τ) since M*(M−1)/2 different microphone pairs are present (213). Here, a spectrum weight w(k) is obtained using Expression 7 and a total frequency band is divided into two parts, a low frequency region and a high frequency region, and a value less than 1 is applied as an additional frequency band weight μ(k) to the low frequency region and a value higher than 1 is applied as an additional weight μ(k) to the high frequency region. The first beamformer 21 provides the calculated cross-correlation Rₙₚ(τ) of each microphone pair to the second beamformer 23.

The first beamformer 21 calculates the beamformer energy E_{dir} of each sound source for a specific direction by reading a relative delay between each microphone pair for the specific direction from a table and calculating cross-correlations R_{nd}(τ) of all microphone pairs by substituting the read delay into Expression 11 and summing the calculated cross-correlations Rₙₚ(τ) of all microphone pairs (214).

After calculating the beamformer energy E_{dir} of each sound source for each direction, the first beamformer 21 estimates a direction, whose energy is the highest among the N_{d} energies E_{dir} of the sound source, to be a direction \hat{θ}ₙₛ of the sound source (215). The estimated direction of the sound source is provided to a corresponding virtual microphone signal generator 22. The first found direction is a direction of the sound source that is the closest to the microphone array 10 or that has the largest power.

Then, the first beamformer 21 sets Rₙₚ(τ) corresponding to a delay τ between each microphone pair for the previously found sound source direction to 0 and repeats the above procedure to estimate a next sound source direction (216). The next sound source directions estimated in this manner, are provided to the corresponding virtual microphone signal generators 22.

In FIG. 6B, “ns” is an index of a sound source to be tracked and “Nₛ” denotes the total number of sound sources to be tracked. In addition, “dir” is a sound source direction index and “N_{d}” is the number of directions that may be tracked within the direction tracking range of the beamformer, which is calculated using Expression 9.

The following is a description of the concept of virtual microphone signals.

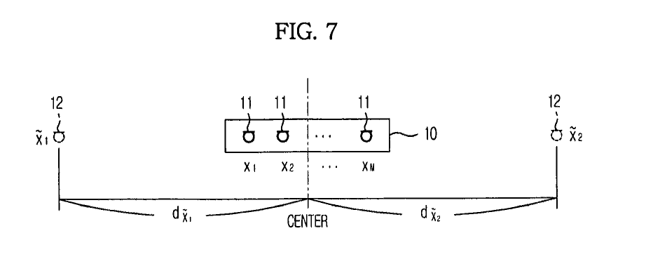

FIG. 7 illustrates the concept of virtual microphone signals in the apparatus to localize multiple sound sources according to an embodiment.

As shown in FIG. 7, it is assumed that a pair of virtual microphones 12 is located at both sides of the microphone array 10 at distances which are several times greater than the aperture length of the microphone array 10 from the center of the microphone array 10.

The following is a description of the operation of a virtual microphone signal generator 22.

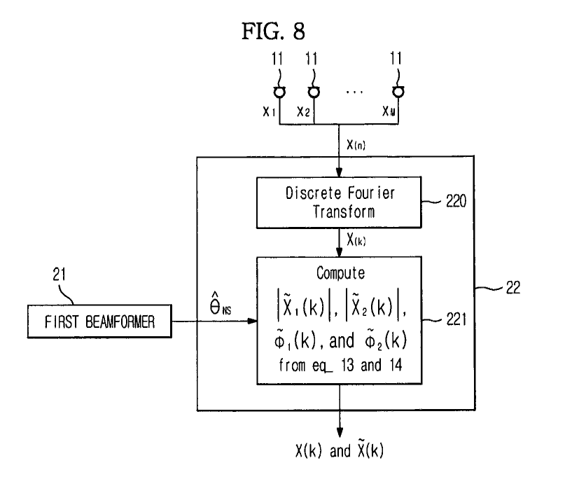

FIG. 8 illustrates the operation of a virtual microphone signal generator 22 in the apparatus to localize multiple sound sources according to an embodiment.

As shown in FIG. 8, the virtual microphone signal generator 22 determines two positions, which are located at both sides of the microphone array 10 at preset distances (for example, at distances several times greater than the aperture length of the microphone array 10) from the center of the microphone array 10, to be the positions of two virtual microphones 12 and derives two virtual microphone signals, which arrive at the two determined positions, from actual microphone signals and the primary estimation of the corresponding sound source direction \hat{θ}ₙₛ in the following manner.

That is, upon receiving microphone signals x(n) from the microphone array 10, the virtual microphone signal generator 22 performs Discrete Fourier Transform (DFT) on the received microphone signals x(n) to calculate DFTs X(k) of the microphone signals x(n) (220).

After performing DFT on the microphone signals, the virtual microphone signal generator 22 calculates virtual microphone signals from the DFTs X(k) of the microphone signals x(n) and the primary estimation of the corresponding sound source direction \hat{θ}ₙₛ received from the first beamformer 21 in the following manner (221).

$$\begin{matrix}\vert {\tilde{X}}_{1} ( k ) \vert = \vert {\tilde{X}}_{2} ( k ) \vert = \frac{1}{M} {\sum }_{m = 1}^{M} \vert {X}_{m} ( k ) \vert & Expression 13 \\ {\tilde{φ}}_{1} ( k ) = 2 π ( k - 1 ) \frac{{f}_{s}}{{N}_{f}} \frac{{d}_{{\tilde{x}}_{1}} sin {\hat{θ}}_{ns}}{c} \\ {\tilde{φ}}_{2} ( k ) = 2 π ( k - 1 ) \frac{{f}_{s}}{{N}_{f}} \frac{{d}_{{\tilde{x}}_{2}} sin {\hat{θ}}_{ns}}{c} & Expression 14\end{matrix}$$

Here, it is assumed that the virtual microphones are spaced farther apart from the sound sources than the microphone array 10. However, since too small levels of virtual microphone signals may cause a problem in cross-correlation calculation and correct direction tracking depends more on phase than on magnitude, the levels of the virtual microphone signals are replaced with an average level of M actual microphone signals using Expression 13.

The virtual microphone signal generator 22 separately obtains the phases of the virtual microphone signals for the calculated primary direction estimation \hat{θ}ₙₛ from both the calculated primary direction estimation and the distances d_{\tilde{x}}_{₁} and d_{\tilde{x}}_{₂} between the center of the microphone array 10 and the virtual microphones using Expression 14.

In addition, the virtual microphone signal generator 22 generates Fourier transforms of the virtual microphone signals of the corresponding direction estimation using the phases and magnitudes of the virtual microphone signals calculated using Expressions 13 and 14 and provides the transforms of the virtual microphone signals together with the Fourier transforms of the actual microphone signals to the corresponding second beamformer 23.

$${\tilde{X}}_{1} ( k ) = \vert {\tilde{X}}_{1} ( k ) \vert {e}^{( \sqrt{- 1} ) {\tilde{φ}}_{1} ( k )} \\ {\tilde{X}}_{2} ( k ) = \vert {\tilde{X}}_{2} ( k ) \vert {e}^{( \sqrt{- 1} ) {\tilde{φ}}_{2} ( k )} \qquad Expression 15$$

The following is a description of the operation of a second beamformer 23.

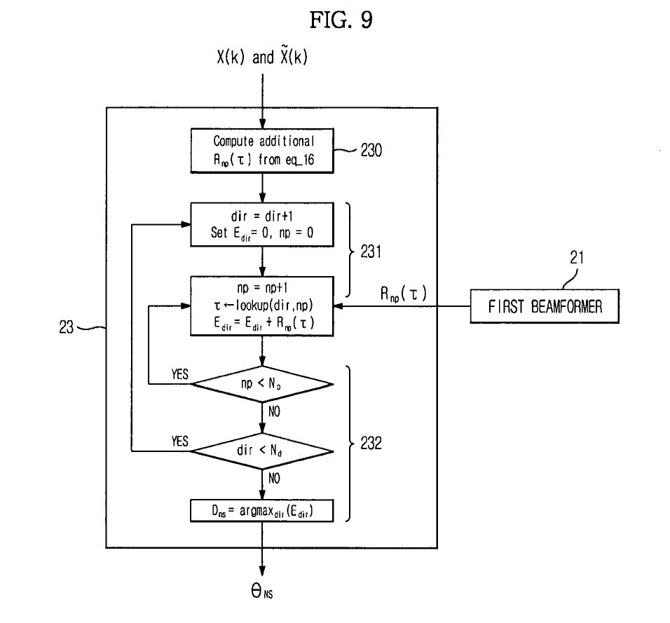

FIG. 9 illustrates the operation of a second beamformer of the apparatus to localize multiple sound sources according to an embodiment.

As shown in FIG. 9, for each sound source direction, a corresponding second beamformer 23 estimates a corresponding sound source direction based on Fourier transforms \tilde{X}₁(k) and \tilde{X}₂(k) of virtual microphone signals of a corresponding direction estimation received from the virtual microphone signal generator 22, Fourier transforms X₁(k), . . . , X_{M}(k) of actual microphone signals, and a cross-correlation rₙₚ(τ) of each microphone pair received from the first beamformer 21.

More specifically, the number of microphone pairs Nₚ is (M+2)*(M−1)/2 since a total of M+2 microphone signals is generated due to addition of the virtual microphone signals \tilde{X}₁(k) and \tilde{X}₂(k).

Accordingly, the second beamformer 23 calculates delays τ of the newly added microphone pairs using Expression 8 and adds the calculated delays to the existing delay table and also calculates the cross-correlations of the newly added microphone pairs using the following Expression 16 (230).

$${R}_{np} ( τ ) = {\sum }_{k = 0}^{L - 1} \frac{{μ}^{2} ( k ) {w}^{2} ( k ) {X}_{i} ( k ) {\tilde{X}}_{j}^{*} ( k )}{\vert {X}_{i} ( k ) \vert \vert {\tilde{X}}_{j} ( k ) \vert} {e}^{( \sqrt{- 1} ) 2 π k τ / L} \\ {R}_{{N}_{p}} ( τ ) = {\sum }_{k = 0}^{L - 1} \frac{{μ}^{2} ( k ) {w}^{2} ( k ) {\tilde{X}}_{1} ( k ) {\tilde{X}}_{2}^{*} ( k )}{\vert {\tilde{X}}_{1} ( k ) \vert \vert {\tilde{X}}_{2} ( k ) \vert} {e}^{( \sqrt{- 1} ) 2 π k τ / L} \qquad Expression 16$$

In Expression 16, “np” is a newly added microphone pair index and “Nₚ” denotes a virtual microphone pair which is the last pair. In addition, “i” is an actual microphone index and “j” is a virtual microphone index.

Then, the second beamformer 23 calculates the beamformer energy E_{dir} of the corresponding sound source using cross-correlations that have been extended by adding the result of Expression 16 to the calculated cross-correlations Rₙₚ(τ) between actual microphone pairs (231).

After calculating the beamformer energy E_{dir} of the corresponding sound source, the second beamformer 23 estimates a direction, which has the highest of the N_{d} energies E_{dir} of the corresponding sound source, to be a direction of the corresponding sound source (232).

Although the first beamformer 21 of FIG. 6 estimates all directions of the Nₛ sound sources as described above, the second beamformer 23 calculates only the direction of the corresponding one of the Nₛ sound sources based on the actual microphone signals and the virtual microphone signals that are derived for the corresponding sound source separately from those of the other sound sources as shown in FIG. 9.

As shown in FIG. 3, a corresponding pair of a virtual microphone signal generator 22 and a second beamformer 23 is driven in parallel for each primary direction estimation. A corresponding pair of a virtual microphone signal generator 22 and a second beamformer 23 may be driven each time direction estimation is updated at the first beamformer 21 when the circumstances permit.

As is apparent from the above description, in an apparatus and method to localize multiple sound sources according to the embodiments, virtual microphone signals are generated based on actual microphone signals from a microphone array including a plurality of microphones, which are arranged at intervals that may minimize space aliasing at a given sampling frequency, and sound source directions are tracked using the actual microphone signals and the virtual microphone signals. Therefore, without increasing the aperture length of the microphone array, it may be possible to achieve almost the same resolution as when a microphone array having a relatively long aperture length is used.

In addition, since sound source directions are tracked using the actual microphones of the microphone array and virtual microphones assuming that the virtual microphones are located at both sides of the microphone array, it may be possible to increase resolution to almost the same level as when a microphone array including a larger number of microphones is used or when a microphone array having an aperture size increased by increasing the inter-microphone distance is used and it may thus be possible to more efficiently track sound source directions.

Further, since it may be possible to significantly reduce the size of the microphone array compared to a microphone array that achieves the same resolution, the apparatus may be easily applied to a mobile device while significantly contributing to design differentiation of products including digital TVs.

Although a few embodiments have been shown and described, it would be appreciated by those skilled in the art that changes may be made in embodiments without departing from the principles and spirit of the invention, the scope of which is defined in the claims and their equivalents.

What is claimed is:

1. An apparatus to localize multiple sound sources, the apparatus comprising:
a microphone array including a plurality of linearly arranged microphones; and
a sound source tracking unit to perform primary estimation of a plurality of sound source directions using microphone signals received from the microphone array, generate a virtual microphone signal based on the received microphone signals for each of the primarily estimated sound source directions, and perform secondary estimation of the plurality of sound source directions using the received microphone signals and the generated virtual microphone signals.

2. The apparatus according to claim 1, wherein the sound source tracking unit comprises:
a first beamformer to receive microphone signals from the microphone array and perform beamforming using the received microphone signals to perform primary estimation of a plurality of sound source directions;
a virtual microphone signal generator to generate a virtual microphone signal based on the received microphone signals for each of the primarily estimated sound source directions; and
a second beamformer to perform beamforming using the received microphone signals and the generated virtual microphone signal to perform secondary estimation of the plurality of sound source directions.

3. The apparatus according to claim 2, wherein the first beamformer calculates delay values of a plurality of sound source directions for each microphone pair of the microphone array, performs Discrete Fourier Transform (DFT) on the microphone signals received from the microphone array, calculates a cross-spectrum of each microphone pair using the DFTed microphone signals, calculates a cross-correlation of each microphone pair according to the calculated cross-spectrum of the microphone pair, calculates beamformer energies of each sound source for corresponding sound source directions according to the calculated cross-correlation and the calculated delay values, and estimates a direction, which has highest energy among the calculated beamformer energies of the sound source for the corresponding sound source directions, to be a direction of the sound source.

4. The apparatus according to claim 3, wherein the first beamformer applies a weight to the cross-correlation when calculating the cross-correlation while increasing the applied weight when a frequency band of the microphone signals is higher than a preset band and decreasing the applied weight when the frequency band of the microphone signals is lower than the preset band.

5. The apparatus according to claim 2, wherein the virtual microphone signal generator generates the virtual microphone signal based on microphone signals received from the microphone array and the primarily estimated sound source directions when a virtual microphone is located at either side of the microphone array at a preset distance from a center of the microphone array.

6. The apparatus according to claim 3, wherein the second beamformer estimates, for each of the primarily estimated sound source directions, a corresponding sound source direction based on a Fourier transform of the generated virtual microphone signal, Fourier transforms of the microphone signals received from the microphone array, and the cross-correlation calculated by the first beamformer.

7. The apparatus according to claim 6, wherein the second beamformer calculates a delay value of a corresponding sound source direction for each microphone pair in all microphones including the microphones of the microphone array and the virtual microphone, calculates cross-spectrums of all the microphone pairs according to a Fourier transform of the virtual microphone signal and the Fourier transforms of the microphone signals received from the microphone array, calculates cross-correlations of all the microphone pairs according to the calculated cross-spectrums of all the microphone pairs, calculates beamformer energies of each sound source for corresponding sound source directions according to the calculated cross-correlations and the calculated delay value, and estimates a direction, which has highest energy among the calculated beamformer energies of the sound source for the corresponding sound source directions, to be a direction of the sound source.

8. The apparatus according to claim 1, wherein the microphones of the microphone array are arranged at intervals that minimize space aliasing at a given sampling frequency.

9. A method to control an apparatus to localize multiple sound sources, the apparatus comprising a microphone array including a plurality of linearly arranged microphones and a sound source tracking unit to estimate sound source directions according to microphone signals received from the microphone array, the method comprising:
performing primary estimation of a plurality of sound source directions using microphone signals received from the microphone array;
generating a virtual microphone signal based on the received microphone signals for each of the primarily estimated sound source directions; and
performing secondary estimation of the plurality of sound source directions using the received microphone signals and the generated virtual microphone signals.

10. The method according to claim 9, wherein performing primary estimation of the plurality of sound sources comprises calculating delay values of a plurality of sound source directions for each microphone pair of the microphone array, performing Discrete Fourier Transform (DFT) on the microphone signals received from the microphone array, calculating a cross-spectrum of each microphone pair using the DFTed microphone signals, calculating a cross-correlation of each microphone pair according to the calculated cross-spectrum of the microphone pair, calculating beamformer energies of each sound source for corresponding sound source directions according to the calculated cross-correlation and the calculated delay values, and estimating a direction, which has highest energy among the calculated beamformer energies of the sound source for the corresponding sound source directions, to be a direction of the sound source.

11. The method according to claim 10, wherein calculating the cross-correlation comprises applying a weight to the cross-correlation when calculating the cross-correlation while increasing the applied weight when a frequency band of the microphone signals is higher than a preset band and decreasing the applied weight when the frequency band of the microphone signals is lower than the preset band.

12. The method according to claim 9, wherein generating the virtual microphone signal comprises generating the virtual microphone signal based on microphone signals received from the microphone array and the primarily estimated sound source directions when a virtual microphone is located at either side of the microphone array at a preset distance from a center of the microphone array.

13. The method according to claim 10, wherein performing secondary estimation of the plurality of sound sources comprises estimating, for each of the primarily estimated sound source directions, a corresponding sound source direction based on a Fourier transform of the generated virtual microphone signal, Fourier transforms of the microphone signals received from the microphone array, and the calculated cross-correlation.

14. The method according to claim 13, wherein performing secondary estimation of the plurality of sound source directions comprises calculating a delay value of a corresponding sound source direction for each microphone pair in all microphones including the microphones of the microphone array and the virtual microphone, calculating cross-spectrums of all the microphone pairs according to a Fourier transform of the virtual microphone signal and the Fourier transforms of the microphone signals received from the microphone array, calculating cross-correlations of all the microphone pairs according to the calculated cross-spectrums of all the microphone pairs, calculating beamformer energies of each sound source for corresponding sound source directions according to the calculated cross-correlations and the calculated delay value, and estimating a direction, which has highest energy among the calculated beamformer energies of the sound source for the corresponding sound source directions, to be a direction of the sound source.

15. The apparatus according to claim 5, wherein a distance between the virtual microphones is greater than the length of the microphone array.

16. The method according to claim 12, wherein a distance between the virtual microphones is greater than the length of the microphone array.
